(19) United States
(12) Patent Application Publication
(10) Pub. No.: US 2015/0282138 A1
(43) Pub. Date: Oct. 1, 2015

(54) SOFT BUFFER SIZE DETERMINATION METHOD FOR DUAL CONNECTIVITY

(71) Applicant: Samsung Electronics Co., Ltd., Suwon-si (KR)

(72) Inventors: Seunghoon CHOI, Suwon-si (KR); Youngbum KIM, Seoul (KR); Hyoungju JI, Seoul (KR)

(21) Appl. No.: 14/674,671

(22) Filed: Mar. 31, 2015

(30) Foreign Application Priority Data
Mar. 31, 2014 (KR) 10-2014-0037497

(51) Int. Cl. H04W 72/04; H04L 5/00

(52) U.S. Cl. CPC H04W 72/042; H04L 5/0092

(57) ABSTRACT

A method for a dual connectivity-enabled terminal which receives downlink data from at least one of a macro and a pico base station to transmit uplink control information corresponding to downlink data is provided. The method includes receiving the downlink data from a base station, determining whether the terminal is configured with a secondary cell group (SCG), determining, if the terminal is configured with the SCG, a size of a soft buffer per code block per cell based on a number of configured serving cells of the terminal, and storing the received downlink data in the soft buffer based on the size of the soft buffer per code block per cell, wherein the configured serving cells are included in a master cell group (MCG) and the SCG.

### CROSS-REFERENCE TO RELATED APPLICATION(S)

This application claims the benefit under 35 U.S.C. §119(a) of a Korean patent application filed on Mar. 31, 2014 in the Korean Intellectual Property Office and assigned Serial number 10-2014-0037497, the entire disclosure of which is hereby incorporated by reference.

### TECHNICAL FIELD

The present disclosure relates to a cellular radio communication system. More particularly, the present disclosure relates to a method for a dual connectivity-enabled terminal which receives downlink data from at least one of a macro and a pico base station to transmit uplink control information corresponding to downlink data.

### BACKGROUND

Currently, many researches are conducted on Orthogonal Frequency Division Multiple Access (OFDMA) and Single Carrier-Frequency Division Multiple Access (SC-FDMA) as multiple access methods for high speed data transmission on the radio channel. Such multiple access methods are characterized in that the time-frequency resources are allocated to carry user-specific data and control information without being overlapped, i.e., maintaining orthogonality, so as to distinguish among user-specific data and control information.

In cellular radio communication system, one of the significant factors to provide high-speed wireless data service is bandwidth scalability for dynamic resource allocation. For example, Long Term Evolution (LTE) system can support the bandwidths of 20/15/10/5/3/1.4 MHz. The carriers can provide services with at least one of the bandwidths, and the user equipment can have different capabilities such that some supports only 1.4 MHz bandwidth and others up to 20 MHz bandwidth. The LTE-Advanced (LTE-A) system, aiming at achieving the requirements of the International Mobile Telecommunications-Advanced (IMT-Advanced) service, can provide broadband service by aggregating carries up to 100 MHz.

The LTE-A system needs the bandwidth wider than that of LTE system for high-speed data transmission. Simultaneously, the LTE-A system needs to be backward compatible with the LTE system such that multiple LTE user equipment (UEs) can access the services of the LTE-A system. For this purpose, the entire system bandwidth of the LTE-A system is divided into sub-bands or component carriers that have a bandwidth supporting transmission or reception of the LTE UE and can be aggregated for supporting the high speed data transmission of the LTE-A system in the transmission/reception process of the legacy LTE system per component carrier. The component carriers or cells are categorized into Primary Cell (PCell) and Secondary Cell. There is only one PCell and the others are SCells in view of the UE. The legacy LTE-A standard specifies that the uplink control channel (Physical Uplink Control Channel (PUCCH)) can be transmitted in the primary cell while the uplink data channel (Physical Uplink Shared Channel (PUSCH)) can be transmitted in both the PCell and SCell.

The scheduling information about the data to be transmitted on the component carriers is sent to the UE in Downlink Control Information (DCI). The DCI is generated in different DCI format according to whether scheduling information is of uplink or downlink, whether the DCI is compact DCI, whether spatial multiplexing with multiple antennas is applied, and whether the DCI is the power control DCI. For example, the DCI format 1 for the control information about downlink data to which Multiple Input Multiple Output (MIMO) is not applied is composed of the control information as follows.
Resource allocation type 0/1 flag notifies the UE of whether the resource allocation type is type 0 or type 1. Here, type 0 indicates resource allocation in unit of resource block group (RBG) in bitmap method. In LTE and LTE-A systems, the basic scheduling unit is resource block (RB) representing time and frequency resource, and RBG is composed of a plurality of RBs and basic scheduling unit of in type 0. Type 1 indicates allocation of specific RB in RBG.
Resource block assignment notifies the UE of RB allocated for data transmission. At this time, the resource expressed according to the system bandwidth and resource allocation method is determined.
Modulation and coding scheme notifies the UE of modulation scheme and coding rate applied for data transmission.
Hybrid automatic repeat request (HARQ) process number notifies the UE of HARQ process number.
New data indicator notifies the UE of whether the transmission is HARQ initial transmission or retransmission.
Redundancy version notifies the UE of redundancy version of HARQ.
Transmit Power Control (TPC) command for PUCCH notifies the UE of power control command for PUCCH as uplink control channel.

The device control interface (DCI) is channel-coded and modulated and then transmitted through PDCCH.

FIGS. 1A and 1B illustrate data communication between a dual connectivity-enabled UE and a macro evolved Node B (eNB) and a pico eNB in a dual connectivity environment according to the related art.

Referring to FIG. 1A, a co-channel deployment scenario in which a macro eNB 101 and a pico eNB 102 operate on the same frequency channel in a network is illustrated. Referring to FIG. 1A, the dual connectivity enabled UE 105 is capable of performing data communication with the macro and pico eNBs 101 and 102 simultaneously as denoted by reference numbers 103 and 104. FIG. 1B shows a multi-carrier deployment scenario in which a macro eNB 111 and a pico eNB 112 operate on different frequency channels.

Referring to FIG. 1B, the dual connectivity-enabled UE 115 is capable of performing data communication with the macro and pico eNBs 111 and 112 simultaneously as denoted by reference numbers 113 and 114.

Referring to FIGS. 1A and 1B, it is assumed that the macro and pico eNBs have a non-ideal backhaul.

In the state that the dual connectivity-enabled UE communicates with the macro eNB, a pico eNB operating on a different frequency may be configured to the dual connectivity-enabled UE to increase data rate. In this case, the macro and pico eNBs to which the dual connectivity-enabled UE has connected perform scheduling of downlink data transmission independently. While the macro and pico eNBs performs scheduling of downlink data transmission independently, the dual connectivity-enabled UE has to buffer the downlink data in a soft buffer. However, the soft buffer size of the dual connectivity-enabled UE is restricted and thus there is a need of a method for storing the downlink data scheduled independently and transmitted by the macro and pico eNBs in the restricted soft buffer as long as possible.

Therefore, a need exists for an apparatus and a method for a method for a dual connectivity-enabled terminal which receives downlink data from at least one of a macro and a pico base station to transmit uplink control information corresponding to downlink data.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an apparatus and a method for a method for a dual connectivity-enabled terminal which receives downlink data from at least one of a macro and a pico base station to transmit uplink control information corresponding to downlink data.

In accordance with an aspect of the present disclosure, a method of a terminal for receiving downlink data in communication system supporting dual connectivity is provided. The method includes receiving the downlink data from a base station, determining whether the terminal is configured with a secondary cell group (SCG), determining, if the terminal is configured with the SCG, a size of a soft buffer per code block per cell based on a number of configured serving cells of the terminal, and storing the received downlink data in the soft buffer based on the size of the soft buffer per code block per cell, wherein the configured serving cells are included in a master cell group (MCG) and the SCG.

In accordance with another aspect of the present disclosure, a method for transmitting downlink data of a base station in communication system supporting dual connectivity is provided. The method includes configuring an SCG to a terminal, generating the downlink data to be transmitted to the terminal based on an available size of a soft buffer of the terminal, and transmitting the generated downlink data to the terminal, wherein the transmitted downlink data is stored in the soft buffer of the terminal, wherein a size of the soft buffer per code block per cell is determined based on a number of configured serving cells of the terminal, and wherein the configured serving cells are included in an MCG and the SCG.

In accordance with another aspect of the present disclosure, a terminal for receiving downlink data in communication system supporting dual connectivity is provided. The terminal includes a transceiver configured to transmit and receive a signal, a controller configured to receive the downlink data from a base station, to determine whether the terminal is configured with a SCG, and to determine, if the terminal is configured with the SCG, a size of a soft buffer per code block per cell based on a number of configured serving cells of the terminal and to store the received downlink data in the soft buffer based on the size of the soft buffer per code block per cell, wherein the configured serving cells are included in an MCG and the SCG.

In accordance with another aspect of the present disclosure, a base station for transmitting downlink data in communication system supporting dual connectivity is provided. The base station includes a transceiver configured to transmit and receive a signal, a controller configured to configure an SCG to a terminal, to generate the downlink data to be transmitted to the terminal based on an available size of a soft buffer of the terminal, and to transmit the generated downlink data to the terminal, wherein the transmitted downlink data is stored in the soft buffer of the terminal, wherein a size of the soft buffer per code block per cell is determined based on a number of configured serving cells of the terminal, and wherein the configured serving cells are included in an MCG and the SCG.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIGS. 1A and 1B illustrate data communication between a dual connectivity-enabled user equipment (UE) and a macro evolved Node B (eNB) and a pico eNB in a dual connectivity environment according to the related art;

FIG. 2 illustrates utilization of a soft buffer of a UE for buffering downlink data transmitted by a macro and a pico eNB according to an embodiment of the present disclosure;

FIG. 3 illustrates a concept of a soft buffer management in a dual connectivity environment according to an embodiment of the present disclosure;

FIG. 4 illustrates a concept of a soft buffer management in a dual connectivity environment according to an embodiment of the present disclosure;

FIG. 5 illustrates a concept of a soft buffer management in a dual connectivity environment according to an embodiment of the present disclosure;

FIG. 6 illustrates a concept of a soft buffer management in a dual connectivity environment according to an embodiment of the present disclosure;

FIG. 7A is a flowchart illustrating a downlink data transmission procedure of an eNB in a dual connectivity environment according to an embodiment of the present disclosure;

FIG. 7B is a flowchart illustrating a downlink data reception procedure of a UE in a dual connectivity environment according to an embodiment of the present disclosure;

FIG. 8A is a flowchart illustrating a downlink data transmission procedure of an eNB in a dual connectivity environment according to an embodiment of the present disclosure;

FIG. 8B is a flowchart illustrating a downlink data reception procedure of a UE in a dual connectivity environment according to an embodiment of the present disclosure;

FIG. 9 is a block diagram illustrating a configuration of an eNB according to an embodiment of the present disclosure; and

FIG. 10 is a block diagram illustrating a configuration of a UE according to an embodiment of the present disclosure.

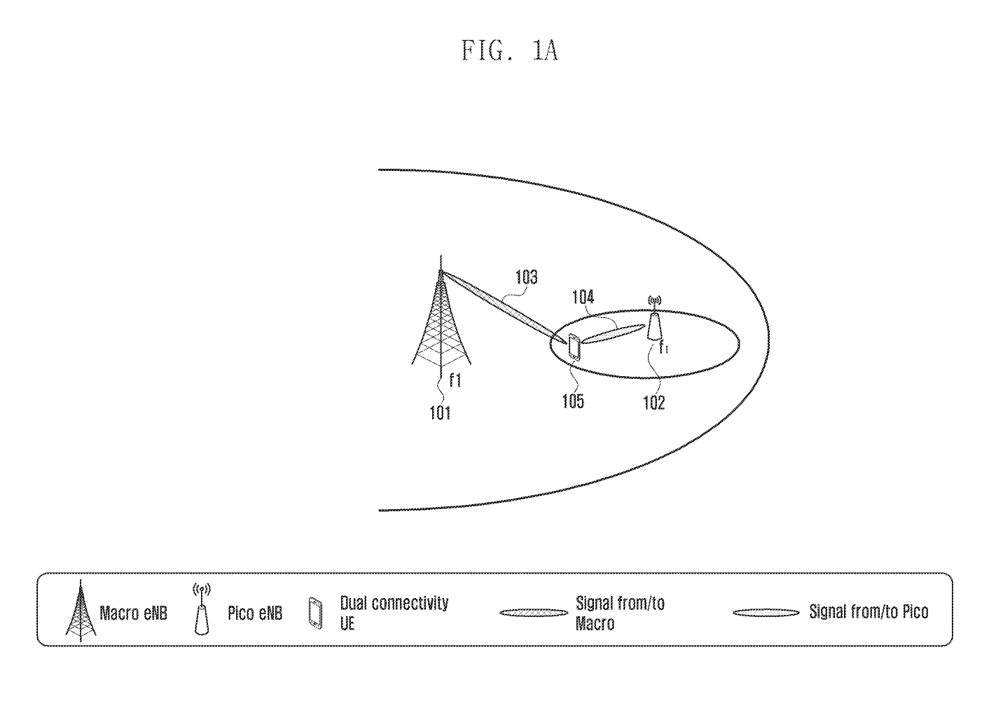

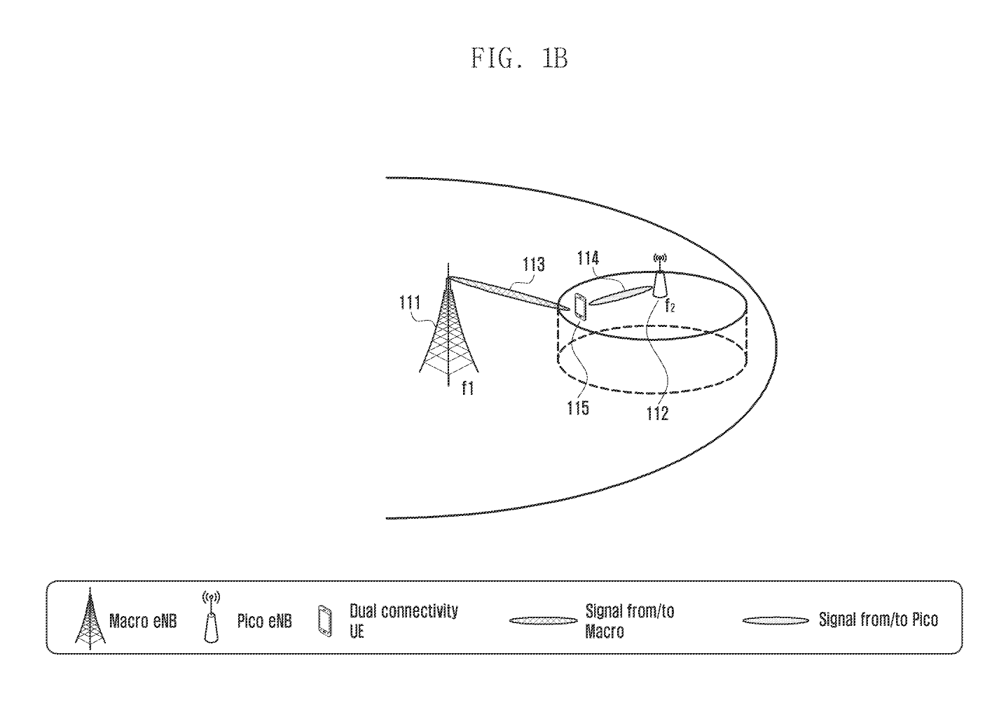

Throughout the drawings, it should be noted that like reference numbers are used to depict the same or similar elements, features, and structures.

### DETAILED DESCRIPTION OF THE DRAWINGS

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, description of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Some elements may be exaggerated, omitted, or simplified in the drawings and the elements may have sizes and/or shapes different from those shown in drawings, in practice. The same reference numbers are used throughout the drawings to refer to the same or like parts.

Further, the following terms are defined based on the functionality in the present disclosure, and may vary according to the intention of a user or an operator, usage, and the like. Therefore, the definition should be made based on the overall content of the present specification.

It will be understood by those skilled in the art that the present disclosure can be applied even to other communication systems having the similar technical background and channel format, with a slight modification, without departing from the spirit and scope of the present disclosure.

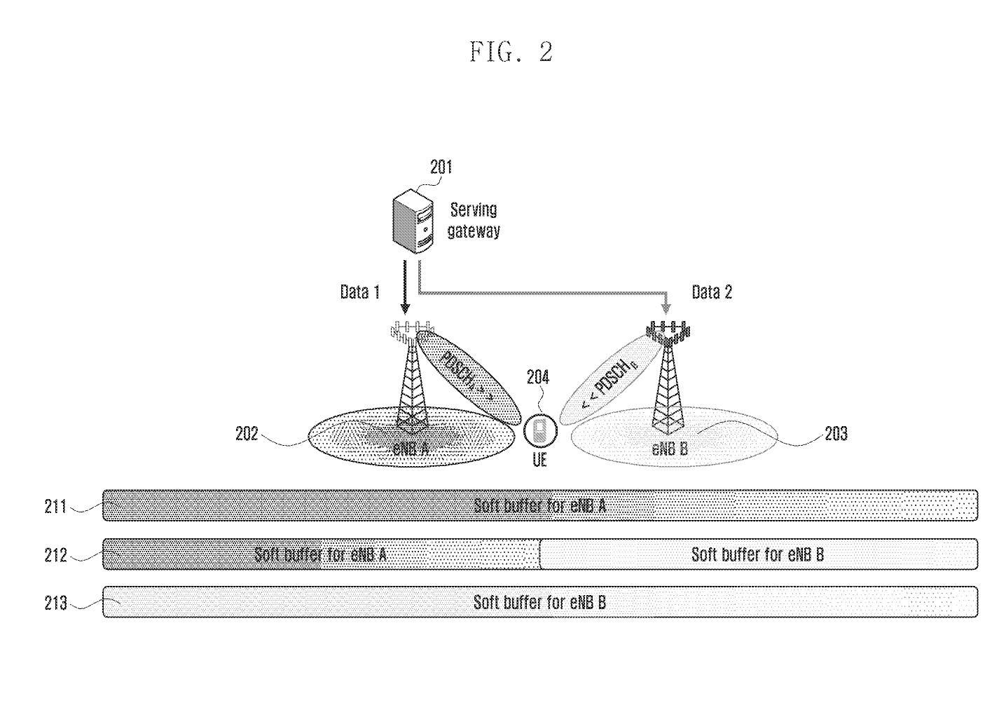

FIG. 2 illustrates utilization of a soft buffer of a UE for buffering downlink data transmitted by a macro and a pico eNB according to an embodiment of the present disclosure.

The macro eNB has at least one cell, and a group of cells which the macro eNB configures to the UE is referred to as Master Cell Group (MCG). The pico eNB has at least one cell, and a group of cells which the pico eNB configures to the UE is referred to as Secondary Cell Group (SCG). In the following description, the terms ‘group of cells which macro eNB configure to UE’ and ‘MCG’ are interchangeably used. In the following description, the terms ‘group of cells which pico eNB configure to UE’ and ‘SCG’ are interchangeably used.

Referring to FIG. 2, a serving gateway 201 distributes data 1 and data 2 to the macro and pico eNBs 202 and 203. The macro eNB 202 performs downlink data transmission to the dual connectivity-enabled UE 204 independently, and the pico eNB 203 performs downlink data transmission to the dual connectivity-enabled UE 204 independently. In the case that only the macro eNB 202 has the downlink data to transmit, the macro eNB 202 performs downlink data transmission based on the whole capacity of the soft buffer of the dual connectivity-enabled UE, and the dual connectivity-enabled UE 204 uses the whole capacity of its soft buffer to buffer the downlink data (soft channel bits) received from the macro eNB 202 as denoted by reference number 211. In the case that both the macro and pico eNBs 202 and 203 have downlink data to transmit, the macro and pico eNBs 202 and 203 perform downlink data transmission based on half of the whole capacity of the soft buffer of the dual connectivity-enabled UE, and the dual connectivity-enabled UE 204 use half of the whole capacity of its soft buffer to buffer the downlink data (soft channel bits) received from the macro eNB 202 and the other half of the soft buffer to buffer the downlink data (soft bits) received from the pico eNB 203 as denoted by reference number 212. In the case that only the pico eNB 203 has the downlink data to transmit, the pico eNB 203 performs downlink data transmission based on the whole data capacity of the soft buffer of the dual connectivity-enabled UE, and the dual connectivity-enabled UE 204 uses the whole capacity of the UE's soft buffer to buffer the downlink data (soft channel bits) received from the pico eNB 203 as denoted by reference number 213. FIG. 2 is directed to the soft buffer utilization method in which the macro and pico eNBs perform data transmission based on the size of the soft buffer of the dual connectivity-enabled UE and the dual connectivity-enabled UE buffers the downlink data (soft channel bits) received from one of or both the macro and pico eNBs in the dual connectivity-enabled UE's soft buffer. However, since the macro and pico eNBs perform downlink scheduling and data transmission independently, it is impossible for one of the macro and pico eNBs to performs the downlink transmission optimally for the UE's soft buffer based on scheduling status of the other eNBs at every subframe and buffer the downlink data from the eNBs to the soft buffer dividedly based on the eNBs' scheduling statuses. Thus the present disclosure proposes a downlink data transmission method that is capable of allowing the dual connectivity-enabled UE to buffer the downlink data transmitted by the macro and pico eNBs in the UE's size-constrained soft buffer without reducing data rate and a downlink data reception method that is capable of allowing the dual connectivity-enabled UE to buffer the downlink data transmitted by one of or both the macro and pico eNBs without discarding as far as possible.

In the above description, the received data decoded from the signal received from the eNBs are soft channel bits and, unless there is no complication, the term ‘decoded soft channel bits’ is interchangeably used with the terms ‘downlink data’ and ‘received downlink data’ through the out the specification.

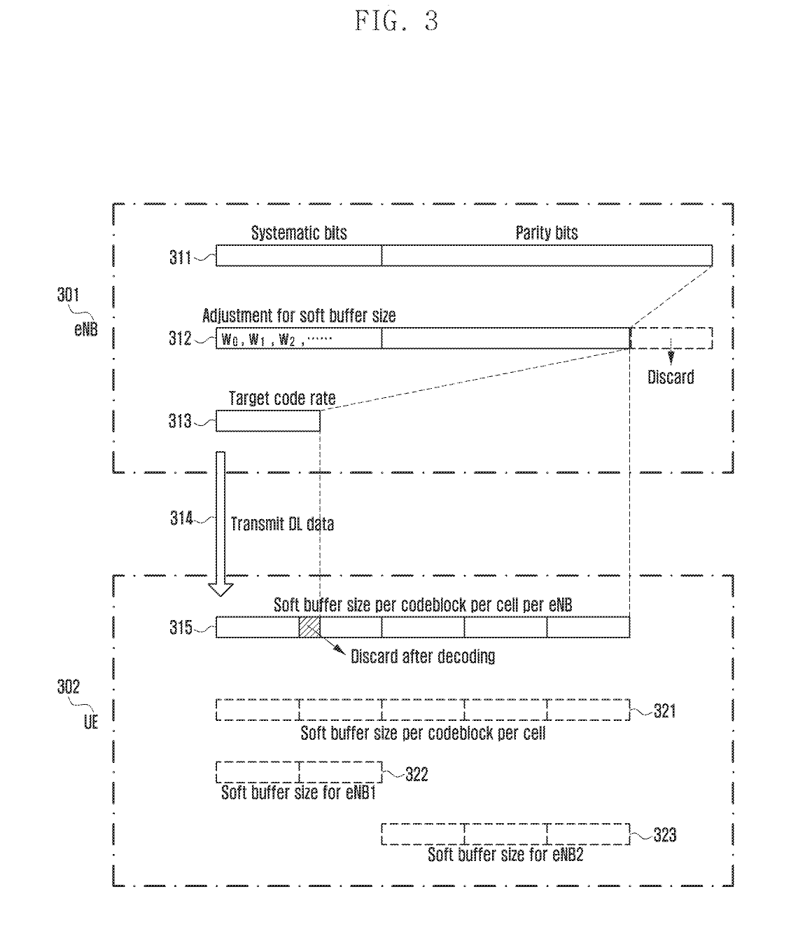

FIG. 3 illustrates a concept of a soft buffer management in a dual connectivity environment according to an embodiment of the present disclosure. FIG. 3 is directed to the case where the macro and pico eNBs perform downlink data transmission based on the status of the soft buffer of the UE and the UE buffers the downlink data in the UE's soft buffer without discarding as far as possible.

Referring to FIG. 3, reference numbers 311, 312, and 313 indicate operations of generating downlink data to be transmitted by an eNB 301 (macro or pico eNB) based on the UE's soft buffer status. Reference number 314 indicates downlink data transmission from the eNB 301 to the UE 302. Reference number 315 indicates the soft buffer size for buffering the soft channel bits received from the eNB 301. Reference numbers 321, 322, and 323 indicate the soft buffer divided for receiving downlink data from the macro eNB and/or the pico eNB.

FIG. 3 is directed to the case where the UE operates in the carrier aggregation mode so as to be configured with two serving cells of the macro eNB and 3 serving cells of the pico eNB. The UE divides the UE's soft buffer into 5 sections for the respective serving cells to buffer the soft channel bits per cell. Reference number 322 indicates the two buffer sections of the soft buffer that are assigned for buffering the downlink data from the eNB 1 (here, macro eNB), and reference number 323 indicates the three buffer sections of the soft buffer that are assigned for buffering the downlink data from the eNB 2 (here, pico eNB). The soft buffer may be divided into multiple buffer sections corresponding to the cells of the eNB 1 and eNB 2 based on the number of layers, the number of Transport Blocks (TBs), and bandwidth of each cell of the eNBs 1 and 2. The more the number of layers or TBs is or the wider the cell's bandwidth is, the larger the soft buffer size of the cell is.

The eNB 301 performs channel coding on the code block (information bits) to generate parity bits at operation 311 and concatenates the code block (information bits) and the parity bits to generate a codeword. The codeword has a size of Kw.

The eNB 301 processes the codeword to be fit for soft buffer of the UE by taking notice of the soft buffer size 321 and discards the rest part of the codeword as denoted by reference number 213. As a consequence, the processed codeword has a size of N_{cb}, which is determined based on NIR, C, and Kw as shown in Equation 1.

$${N}_{cb} = min ( ⌊ \frac{{N}_{IR}}{C} ⌋ , {K}_{w} ) \qquad Equation 1$$

In Equation 1, C denotes the number of code blocks, and N_{IR} is a variable defined by Equation 2.

$${N}_{IR} = ⌊ \frac{{N}_{soft}}{{K}_{C} \cdot {K}_{MIMO} \cdot min ( {M}_{DL\_HARQ} , {M}_{limit} )} ⌋ \qquad Equation 2$$

In Equation 2, N_{soft} denotes the soft buffer size of the UE, K_{C} denotes a constant defined by UE category, K_{MIMO} is a parameter set to 2 for the transmission mode of transmitting two TBs and 1 for the transmission mode of transmitting 1 TB, M_{DL}_{_{—}}_{HARQ} denotes the maximum number of downlink hybrid automatic repeat request (HARQ) processes, and Mₗᵢₘᵢₜ is set to 8.

The eNB 301 processes the codeword adjusted to fit for the soft buffer size into the transmission signal to be fit for the resource scheduled to the UE 302 at operation 313. The eNB transmits the transmission signal to the UE 302 at operation 314. Referring to FIG. 3, the UE 302 divides the UE's soft buffer into a plurality of buffer sections corresponding to the cells of the macro and pico eNBs that are configured to the UE to buffer the code blocks per cell.

The UE 302 buffers a cell-specific signal received from the eNB in the soft buffer at operation 315. At this time, the UE 302 can use the currently available soft buffer capacity for storing the received signal. The currently available soft buffer capacity may be determined by the UE 302 based on the soft buffer size 321 or eNB-specific (here, macro eNB) soft buffer size 322. The UE buffers the soft channel bits that are decoded from the received signal in the soft buffer per eNB per cell per code block. At this time, if the size of the soft channel bits is greater than the soft buffer size per eNB per cell per code block, the UE 302 buffers the soft channel bits as much as the size of the soft buffer of the per eNB per cell per code block and discards the remainder. At this time, the UE buffers the soft channel bits at the positions of wk, wk+1, . . . , wmod (k+n_SB−1, N_cb) as denoted by reference number 312. Here, n_{SB} is defined by Equation 3, and k is selected by the UE.

$${n}_{SB} = min ( {N}_{cb} , \vert \frac{{N}_{soft}^{l}}{\begin{matrix}C \cdot ( {N}_{eNB 1 , cells}^{DL} + {N}_{eNB 2 , cells}^{DL} ) \cdot \\ {K}_{MIMO} \cdot min ( {M}_{DL\_HARQ} , {M}_{limit} )\end{matrix}} \vert ) \qquad Equation 3$$

In Equation 3, N_{soft′} denotes the soft buffer size of the UE, N_{cb} denotes the size of the soft buffer per code block, C denotes the number of code blocks, N_{eNB1,cells}^{DL} denotes the number of cells of eNB 1 (macro eNB) which are configured to the UE, N_{eNB2,cells}^{DL} denotes the number of cells of eNB 2 (pico eNB) which are configured to the UE, K_{MIMO} is set to 2 for the transmission mode of transmitting two TBs and 1 for the transmission mode of transmitting one TB, M_{DL}_{_{—}}_{HARQ} denotes the maximum number of downlink HARQ processes, and Mₗᵢₘᵢₜ is 8.

Referring to FIG. 3, the macro or pico eNB can transmit the downlink data based on the whole capacity of the soft buffer of the dual connectivity-enabled UE without consideration of the scheduling status of the other eNB. Since the transmission is performed based on the whole capacity of the soft buffer of the UE, it is possible to increase the downlink data rate.

Since the cell configuration to the dual connectivity-enabled UE are processed in association with the information on the numbers cells of the eNBs 1 and 2 (i.e., N_{eNB1,cells}^{DL} and N_{eNB2,cells}^{DL}), it is possible to reuse the number of cells when adding new cells through higher layer signaling in the legacy CA. In the case of setting the total number of the cells configured to the dual connectivity-enabled UE to the sum of numbers of the cells of the respective eNBs that are configured to the UE (N_{cells}^{DL}(=N_{eNB1,cells}^{DL}+N_{eNB2,cells}^{DL})), it is necessary to configure an identifier for identifying whether the cell configuration information is sent by the eNB 1 or the eNB 2, such as sCell-Id-r12, in the SCellToAddMod-r10 information as shown in table 1. The sCell-Id-r12 may be set to 0 for the cell configuration information from the eNB 1 and 1 for the cell configuration information from the eNB 2.

TABLE 1

| | |
|---|---|
| SCellToAddMod-r10 ::= | SEQUENCE { |

| sCell-Id-r12 | |
|---|---|
| sCellIndex-r10 | SCellIndex-r10, |
| cellIdentification-r10 | SEQUENCE { |

| | |
|---|---|
| physCellId-r10 | PhysCellId, |
| d1-CarrierFreq-r10 | ARFCN-ValueEUTRA |

| | |
|---|---|
| } | OPTIONAL, -- Cond SCellAdd |

| | |
|---|---|
| radioResourceConfigCommonSCell-r10 | RadioResourceConfigCommonSCell-r10 OPTIONAL, -- Cond |

SCellAdd

| | | |
|---|---|---|
| radioResourceConfigDedicatedSCell-r10 | RadioResourceConfigDedicatedSCell-r10 | OPTIONAL, -- |

Cond SCellAdd2

| ..., | | |
|---|---|---|
| [[ d1-CarrierFreq- [symbol] 1090 | ARFCN-ValueEUTRA-v9e0 | OPTIONAL -- Cond EARFCN-max |

]]

} [symbol]
indicates data missing or illegible when filed

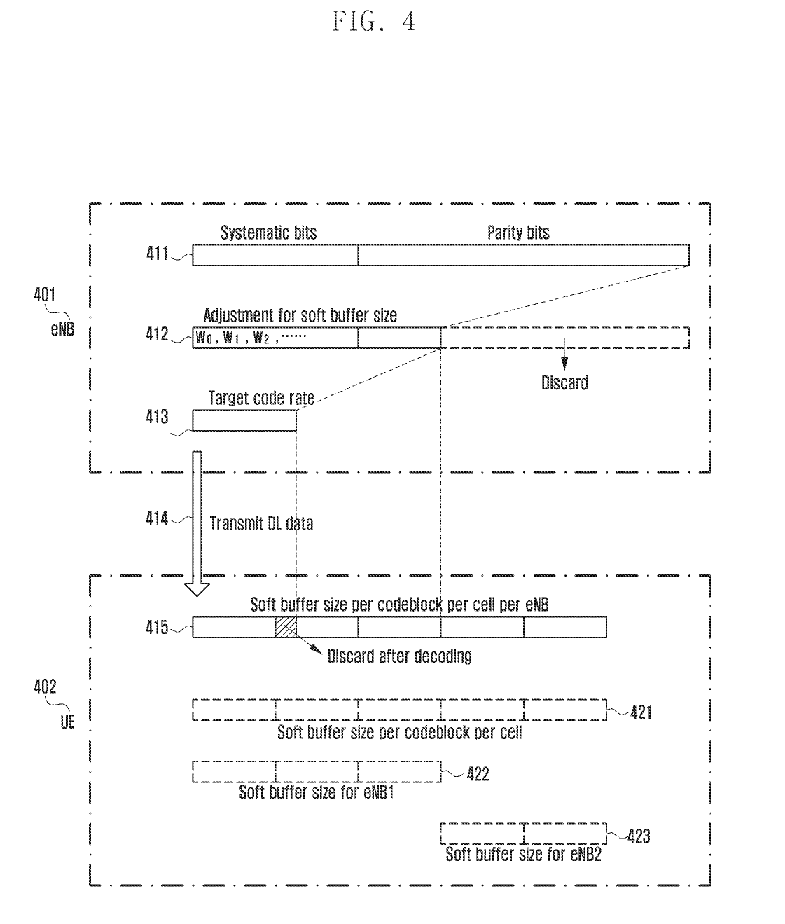

FIG. 4 illustrates a concept of a soft buffer management in a dual connectivity environment according to an embodiment of the present disclosure. The embodiment of FIG. 4 is directed to the case where the macro and pico eNBs perform downlink data transmission based on the status of the soft buffer of the UE such that the UE buffers the eNB-specific downlink data in the UE's soft buffer efficiently.

Referring to FIG. 4, reference numbers 411, 412, and 413 indicate operations of generating downlink data to be transmitted by an eNB 401 (macro or pico eNB) based on the UE's soft buffer status. Reference number 414 indicates downlink data transmission from the eNB 401 to the UE 402. Reference number 415 indicates the soft buffer size for buffering the soft channel bits received from the eNB 401. Reference numbers 421, 422, and 423 indicate the soft buffer divided for receiving downlink data from the macro eNB and/or the pico eNB.

Referring to FIG. 4, it is assumed that the UE operating in the carrier aggregation mode is configured with three serving cells of the macro eNB and two serving cells of the pico eNB. The UE divides the UE's soft buffer into 5 sections for the respective serving cells to buffer the soft channel bits per cell. Reference number 422 indicates the three buffer sections of the soft buffer that are assigned for buffering the downlink data from the eNB 1 (here, macro eNB), and reference number 423 indicates the two buffer sections of the soft buffer that are assigned for buffering the downlink data from the eNB 2 (here, pico eNB). The soft buffer may be divided into multiple buffer sections corresponding to the cells of the eNB 1 and eNB 2 based on the number of layers, the number of TBs, and bandwidth of each cell of the eNBs 1 and 2. The more the number of layers or TBs is or the wider the cell's bandwidth is, the larger the soft buffer size of the cell is.

The eNB 401 performs channel coding on the code block (information bits) to generate parity bits at operation 411 and concatenates the code block (information bits) and the parity bits to generate a codeword. The codeword has a size of Kw.

The eNB 401 processes the codeword to be fit for the soft buffer size assigned to the eNB 401 (here, the soft buffer size 422 because the downlink data transmission of the eNB 1 is assumed, while the soft buffer size 423 for the downlink data transmission of the eNB 2) and discard the rest part of the codeword as denoted by reference number 412. As a consequence, the processed codeword has a size of Ncb, which is determined based on NIR, C, and Kw as shown in Equation 4.

$${N}_{cb} = min ( ⌊ \frac{{N}_{IR}}{C} ⌋ , {K}_{w} ) \qquad Equation 4$$

In Equation 4, C denotes the number of code blocks, and N_{IR} is a variable defined by Equation 5.

$${N}_{IR} = ⌊ \frac{{N}_{soft}}{{K}_{C} \cdot {K}_{MIMO} \cdot min ( {M}_{DL\_HARQ} , {M}_{limit} )} \frac{{N}_{eNBi , cells}^{DL}}{{N}_{eNB 1 , cells}^{DL} + {N}_{eNB 2 , cells}^{DL}} ⌋ \qquad Equation 5$$

In Equation 5, N_{soft} denotes the soft buffer size of the UE, N_{cb} denotes the size of the soft buffer per code block, K_{C} denotes a constant defined by UE category, K_{MIMO} is a parameter set to 2 for the transmission mode of transmitting two TBs and 1 for the transmission mode of transmitting 1 TB, M_{DL}_{_{—}}_{HARQ} denotes the maximum number of downlink HARQ processes, Mₗᵢₘᵢₜ is set to 8, N_{eNB1,cells}^{DL} denotes the number of cells of eNB 1 (macro eNB) that are configured to the UE, N_{eNB2,cells}^{DL} denotes the number of cells of eNB 2 (pico eNB) that are configured to the UE, and N_{eNBi,cells}^{DL} denotes the number of cells of the eNB i (macro or pico eNB) that are configured to the UE.

The eNB 401 processes the codeword adjusted to fit for the soft buffer size allocated to the eNB 401 into the transmission signal to be fit for the resource scheduled to the UE 402 at operation 413. The eNB transmits the transmission signal to the UE at operation 414. Referring to FIG. 4, the UE 402 divides the UE 402's soft buffer into a plurality of buffer sections corresponding to the cells of the macro and pico eNBs that are configured to the UE to buffer the code blocks per cell.

The UE 402 buffers a cell-specific signal received from the eNB 401 in the soft buffer at operation 415. At this time, the UE 402 can use the currently available soft buffer capacity for storing the received signal. The currently available soft buffer capacity may be determined by the UE 402 based on the soft buffer size 421 or eNB-specific (here, macro eNB) soft buffer size 422. The UE buffers the soft channel bits that are decoded from the received signal in the soft buffer per eNB per cell per code block. At this time, if the size of the soft channel bits is greater than the soft buffer size per eNB per cell per code block, the UE 402 buffers the soft channel bits as much as the size of the soft buffer of the per eNB per cell per code block and discards the remainder. At this time, the UE 402 buffers the soft channel bits at the positions of wₖ, wₖ₊₁, . . . , w_{mod (k+n}_{_{—}}_{SB-1, N}_{_{—}}_{cb)} as denoted by reference number 412. Here, n_{SB} is defined by Equation 6, and k is selected by the UE.

$${n}_{SB} = min ( {N}_{cb} , ⌊ \frac{{N}_{soft}^{′}}{\begin{matrix}C \cdot ( {N}_{eNB 1 , cells}^{DL} + {N}_{eNB 2 , cells}^{DL} ) \cdot \\ {K}_{MIMO} \cdot min ( {M}_{DL\_HARQ} , {M}_{limit} )\end{matrix}} ⌋ ) \qquad Equation 6$$

In Equation 6, N_{soft′} denotes the soft buffer size of the UE, N_{cb} denotes the size of the soft buffer per code block, C denotes the number of code blocks, N_{eNB1,cells}^{DL} denotes the number of cells of eNB 1 (macro eNB) which are configured to the UE, N_{eNB2,cells}^{DL} denotes the number of cells of eNB 2 (pico eNB) which are configured to the UE, K_{MIMO} is set to 2 for the transmission mode of transmitting two TBs and 1 for the transmission mode of transmitting one TB, M_{DL}_{_{—}}_{HARQ} denotes the maximum number of downlink HARQ processes, and Mₗᵢₘᵢₜ is 8.

Referring to FIG. 4, the macro or pico eNB can transmit the downlink data based on the soft buffer capacity of the UE which is assigned to the UE among the whole capacity of the soft buffer of the dual connectivity-enabled UE without consideration of the scheduling status of the other eNB. Since the transmission is performed based on the soft buffer capacity assigned to the current eNB, the data rate decreases as compared to the embodiment of FIG. 3 but it is advantageous to reduce the amount of the soft channel bits to be discarded at operation 415.

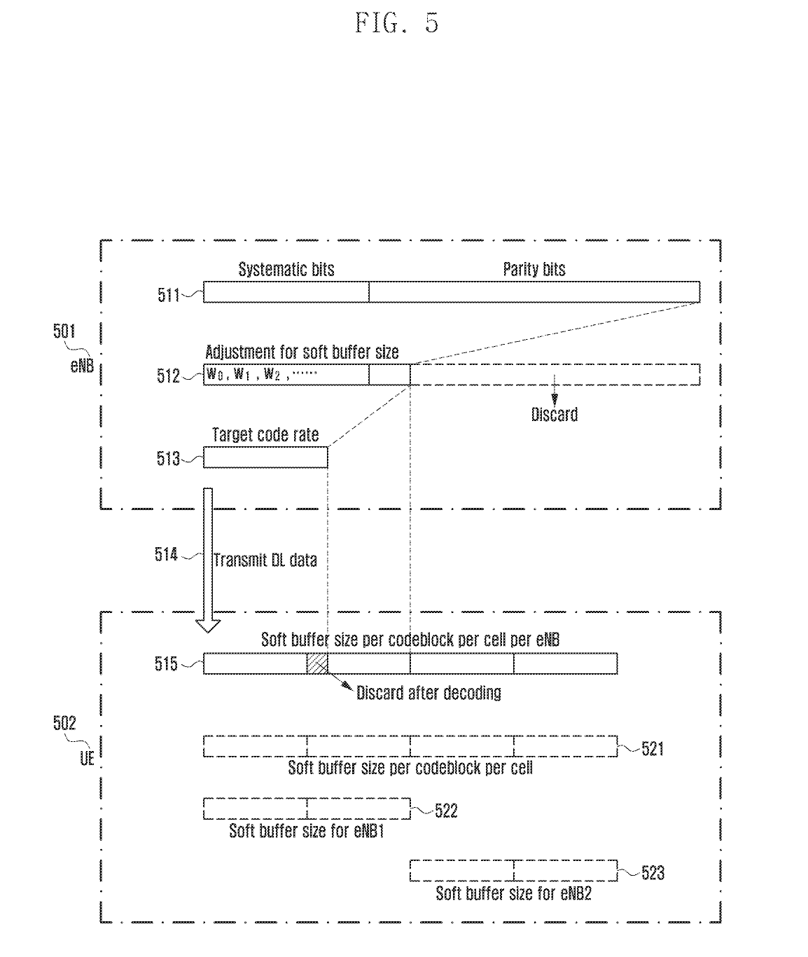

FIG. 5 illustrates a concept of a soft buffer management in a dual connectivity environment according to an embodiment of the present disclosure. The embodiment of FIG. 5 is directed to the case where the macro and pico eNBs perform downlink data transmission based on the soft buffer status of the UE such that the UE buffers the eNB-specific downlink data in the UE's soft buffer efficiently.

Referring to FIG. 5, reference numbers 511, 512, and 513 indicate operations of generating downlink data to be transmitted by an eNB 501 (macro or pico eNB) based on the UE's soft buffer status. Reference number 514 indicates downlink data transmission from the eNB 501 to the UE 502. Reference number 515 indicates the soft buffer size for buffering the soft channel bits received from the eNB 501. Reference numbers 521, 522, and 523 indicate the soft buffer divided for receiving downlink data from the macro eNB and/or the pico eNB.

Referring to FIG. 5, it is assumed that the UE operating in the carrier aggregation mode is configured with three serving cells of the macro eNB of which two cells are activated and two serving cells of the pico eNB which are all activated. For example, total 4 cells (two belonging to the macro cell and two belonging to the pico cell) are configured to the UE for downlink data transmission. The configured and activated cells of each eNB is notified to the UE through higher layer signaling or MAC signaling, and the numbers of activated cells among the eNB-specific cells configured to the UE are share between the eNB through the X2 interface therebetween or the report form the UE. The UE divides the UE's soft buffer into 4 sections for the respective activated cells among the 5 configured cells so as to buffer the soft channel bits per cell. Reference number 522 indicates the 2 buffer sections of the soft buffer that are assigned for buffering the downlink data from the eNB 1 (here, macro eNB), and reference number 523 indicates the two buffer sections of the soft buffer that are assigned for buffering the downlink data from the eNB 2 (here, pico eNB). The soft buffer may be divided into multiple buffer sections corresponding to the cells of the eNB 1 and eNB 2 based on the number of layers, the number of TBs, and bandwidth of each cell of the eNBs 1 and 2. The more the number of layers or TBs is or the wider the cell's bandwidth is, the larger the soft buffer size of the cell is.

The eNB 501 performs channel coding on the code block (information bits) to generate parity bits at operation 511 and concatenates the code block (information bits) and the parity bits to generate a codeword. The codeword has a size of Kw.

The eNB 501 processes the codeword to be fit for the soft buffer size assigned to the eNB 501 (here, the soft buffer size 522 because the downlink data transmission of the eNB 1 is assumed, while the soft buffer size 523 for the downlink data transmission of the eNB 2) and discard the rest part of the codeword as denoted by reference number 512. As a consequence, the processed codeword has a size of Ncb, which is determined based on NIR, C, and Kw as shown in Equation 7.

$${N}_{cb} = min ( ⌊ \frac{{N}_{IR}}{C} ⌋ , {K}_{w} ) \qquad Equation 7$$

In Equation 7, C denotes the number of code blocks, and N_{IR} is a variable defined by Equation 8.

$${N}_{IR} = ⌊ \frac{{N}_{soft}}{{K}_{C} \cdot {K}_{MIMO} \cdot min ( {M}_{DL\_HARQ} , {M}_{limit} )} \frac{{N}_{eNBi , A\_cells}^{DL}}{{N}_{eNB 1 , A\_cells}^{DL} + {N}_{eNB 2 , A\_cells}^{DL}} ⌋ \qquad Equation 8$$

In Equation 8, N_{soft} denotes the soft buffer size of the UE, K_{C} denotes a constant defined by UE category, K_{MIMO} is a parameter set to 2 for the transmission mode of transmitting two TBs and 1 for the transmission mode of transmitting 1 TB, M_{DL}_{_{—}}_{HARQ} denotes the maximum number of downlink HARQ processes, Mₗᵢₘᵢₜ is set to 8, N_{eNB1,A}_{_{—}}_{cells}^{DL} denotes the number of activated cells among the cells of eNB 1 (macro eNB) that are configured to the UE, N_{eNB2,A}_{_{—}}_{cells}^{DL} denotes the number of activated cells among the cells of eNB 2 (pico eNB) that are configured to the UE, and N_{eNBi, A}_{_{—}}_{cells}^{DL} denotes the number of activated cells among the cells of the eNB i (macro or pico eNB) that are configured to the UE.

The eNB 501 processes the codeword adjusted to fit for the soft buffer size allocated to the eNB 501 into the transmission signal to be fit for the resource scheduled to the UE at operation 513. The eNB 501 transmits the transmission signal to the UE at operation 514. Referring to FIG. 5, the UE 502 divides the UE 502's soft buffer into a plurality of buffer sections corresponding to the activated cells among the cells of the macro and pico eNBs that are configured to the UE so as to buffer the code blocks per cell.

The UE 502 buffers a cell-specific signal received from the eNB 501 in the soft buffer at operation 515. At this time, the UE 502 can use the currently available soft buffer capacity for storing the received signal. The currently available soft buffer capacity may be determined by the UE 502 based on the soft buffer size 521 or eNB-specific (here, macro eNB) soft buffer size 522. The UE 502 buffers the soft channel bits that are decoded from the received signal in the soft buffer per eNB per cell per code block. At this time, if the size of the soft channel bits is greater than the soft buffer size per eNB per cell per code block, the UE 502 buffers the soft channel bits as much as the size of the soft buffer of the per eNB per cell per code block and discards the remainder. At this time, the UE 502 buffers the soft channel bits at the positions of wₖ, wₖ₊₁, . . . , w_{mod (k+n}_{_{—}}_{SB-1, N}_{_{—}}_{cb)} as denoted by reference number 512. Here, n_{SB} is defined by Equation 9, and k is selected by the UE.

$${n}_{SB} = min ( {N}_{cb} , ⌊ \frac{{N}_{soft}^{′}}{\begin{matrix}C \cdot ( {N}_{eNB 1 , A\_cells}^{DL} + {N}_{eNB 2 , A\_cells}^{DL} ) \cdot \\ {K}_{MIMO} \cdot min ( {M}_{DL\_HARQ} , {M}_{limit} )\end{matrix}} ⌋ ) \qquad Equation 9$$

In Equation 9, N_{soft′} denotes the soft buffer size of the UE, N_{cb} denotes the size of the soft buffer per code block, C denotes the number of code blocks, N_{eNB1,A}_{_{—}}_{cells}^{DL} denotes the number of activated cells among the cells of eNB 1 (macro eNB) which are configured to the UE, N_{eNB2,A}_{_{—}}_{cells}^{DL} denotes the number of activated cells among the cells of eNB 2 (pico eNB) which are configured to the UE, K_{MIMO} is set to 2 for the transmission mode of transmitting two TBs and 1 for the transmission mode of transmitting one TB, M_{DL}_{_{—}}_{HARQ} denotes the maximum number of downlink HARQ processes, and Mₗᵢₘᵢₜ is 8.

Referring to FIG. 5, the macro or pico eNB can transmit the downlink data based on the soft buffer capacity of the UE which is assigned to the UE among the whole capacity of the soft buffer of the dual connectivity-enabled UE without consideration of the scheduling status of the other eNB. Since the transmission is performed based on the soft buffer capacity assigned to the current eNB, the downlink data rate decreases as compared to the various embodiments of FIGS. 3 and 4 but it is advantageous to reduce the amount of the soft channel bits to be discarded at operation 515.

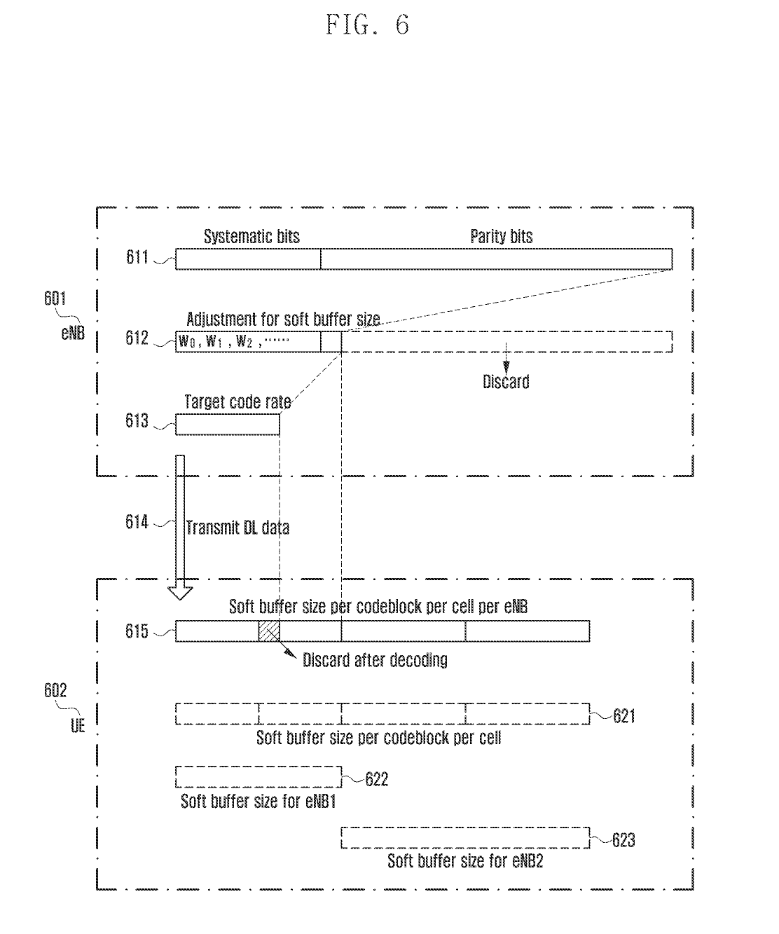

FIG. 6 illustrates a concept of a soft buffer management in a dual connectivity environment according to an embodiment of the present disclosure. The embodiment of FIG. 6 is directed to the case where the macro and pico eNBs perform downlink data transmission based on the soft buffer status of the UE such that the UE buffers the eNB-specific downlink data in the UE's soft buffer efficiently.

Referring to FIG. 6, reference numbers 611, 612, and 613 indicate operations of generating downlink data to be transmitted by an eNB 601 (macro or pico eNB) based on the UE's soft buffer status. Reference number 614 indicates downlink data transmission from the eNB 601 to the UE 602. Reference number 615 indicates the soft buffer size for buffering the soft channel bits received from the eNB 601. Reference numbers 621, 622, and 623 indicate the soft buffer divided for receiving downlink data from the macro eNB and/or the pico eNB.

Referring to FIG. 6, it is assumed that the UE operating in the carrier aggregation mode is configured with two serving cells of the macro eNB and two serving cells of the pico eNB. The UE divides the UE's soft buffer into 4 sections for the respective serving cells to buffer the soft channel bits per cell. The eNBs may share the eNB-specific soft buffer sizes, which are determined based on the downlink data amount, number of layers per cell, number of TBs per cell, bandwidth per cell (the more the number of layers or TBs is or the wider the cell's bandwidth is, the larger the soft buffer size of the cell is), through the X2 interface before scheduling downlink data and transmit the corresponding values to the UE through higher layer signaling. If the soft buffer capacity required for the eNB 1 or the value in proportion thereto is N₁ and the soft buffer capacity required for the eNB 2 or the value in proportion thereto is N₂, the soft buffer size per eNB is N_{soft}*Ni/N1+N2. Here, i=1 for eNB 1 and i=2 for eNB 2.

The UE 602 divides the UE 602's soft buffer into the buffer section for the eNB 1 (here, macro eNB) and the buffer section for the eNB 2 (here, pico eNB) and subdivides the eNB 1 buffer section into two subsections for the two configured cells of the eNB 1 and the eNB 2 buffer section into two subsections for the two configured cells of the eNB 2 for buffering the soft channel bits per cell as denoted by reference number 621. The buffer section for buffering the downlink data from the eNB 1 (macro eNB) has a soft buffer size as denoted by reference number 622, and the buffer section for buffering the downlink data from the eNB 2 (pico eNB) has a soft buffer size as denoted by reference number 623.

The eNB 601 performs channel coding on the code block (information bits) to generate parity bits at operation 611 and concatenates the code block (information bits) and the parity bits to generate a codeword. The codeword has a size of Kw.

The eNB 601 processes the codeword to be fit for the soft buffer size assigned to the eNB 601 (here, the soft buffer size 622 because the downlink data transmission of the eNB 1 is assumed, while the soft buffer size 623 for the downlink data transmission of the eNB 2) and discard the rest part of the codeword as denoted by reference number 612. As a consequence, the processed codeword has a size of Ncb, which is determined based on NIR, C, and Kw as shown in Equation 10.

$${N}_{cb} = min ( ⌊ \frac{{N}_{IR}}{C} ⌋ , {K}_{w} ) \qquad Equation 10$$

In Equation 10, C denotes the number of code blocks, and N_{IR} is a variable defined by Equation 11.

$${N}_{IR} = ⌊ \frac{{N}_{soft}}{{K}_{C} \cdot {K}_{MIMO} \cdot min ( {M}_{DL\_HARQ} , {M}_{limit} )} \frac{{N}_{i}}{{N}_{1} + {N}_{2}} ⌋ \qquad Equation 11$$

In Equation 11, N_{soft} denotes the soft buffer size of the UE, K_{C} denotes a constant defined by UE category, K_{MIMO} is a parameter set to 2 for the transmission mode of transmitting two TBs and 1 for the transmission mode of transmitting 1 TB, M_{DL}_{_{—}}_{HARQ} denotes the maximum number of downlink HARQ processes, Mₗᵢₘᵢₜ is set to 8.

The eNB 601 processes the codeword adjusted to fit for the soft buffer size allocated to the eNB 601 into the transmission signal to be fit for the resource scheduled to the UE at operation 613. The eNB 501 transmits the transmission signal to the UE at operation 614.

Referring to FIG. 6, the UE 602 divides the UE 602's soft buffer into a plurality of buffer sections corresponding to the cells of the macro and pico eNBs that are configured to the UE to buffer the code blocks per cell.

The UE 602 buffers a cell-specific signal received from the eNB in the soft buffer at operation 615. At this time, the UE 602 can use the currently available soft buffer capacity for storing the received signal. The currently available soft buffer capacity may be determined by the UE 602 based on the soft buffer size 621 or eNB-specific (here, macro eNB) soft buffer size 622. The UE buffers the soft channel bits that are decoded from the received signal in the soft buffer per eNB per cell per code block. At this time, if the size of the soft channel bits is greater than the soft buffer size per eNB per cell per code block, the UE 602 buffers the soft channel bits as much as the size of the soft buffer of the per eNB per cell per code block and discards the remainder. At this time, the UE 602 buffers the soft channel bits at the positions of wₖ, wₖ₊₁, . . . , w_{mod (k+n}_{_{—}}_{SB-1, N}_{_{—}}_{cb)} as denoted by reference number 612. Here, n_{SB} is defined by Equation 12, and k is selected by the UE.

$${n}_{SB} = min ( {N}_{cb} , ⌊ \frac{{N}_{soft}^{′}}{C \cdot {N}_{eNBi , cells}^{DL} \cdot {K}_{MIMO} \cdot min ( {M}_{DL\_HARQ} , {M}_{limit} )} \frac{{N}_{i}}{{N}_{1} + {N}_{2}} ⌋ ) \qquad Equation 12$$

In Equation 12, N_{soft′} denotes the soft buffer size of the UE, N_{cb} denotes the size of the soft buffer per code block, C denotes the number of code blocks, N_{eNBi, cells}^{DL} denotes the number of cells of eNB i which are configured to the UE, K_{MIMO} is set to 2 for the transmission mode of transmitting two TBs and 1 for the transmission mode of transmitting one TB, M_{DL}_{_{—}}_{HARQ} denotes the maximum number of downlink HARQ processes, and Mₗᵢₘᵢₜ is 8.

Referring to FIG. 6, the macro or pico eNB can transmit the downlink data based on the soft buffer capacity of the UE which is assigned to the UE among the whole capacity of the soft buffer of the dual connectivity-enabled UE without consideration of the scheduling status of the other eNB, adjust the eNB-specific soft buffer size of the UE dynamically, and share the buffer size information with the other eNB and the UE.

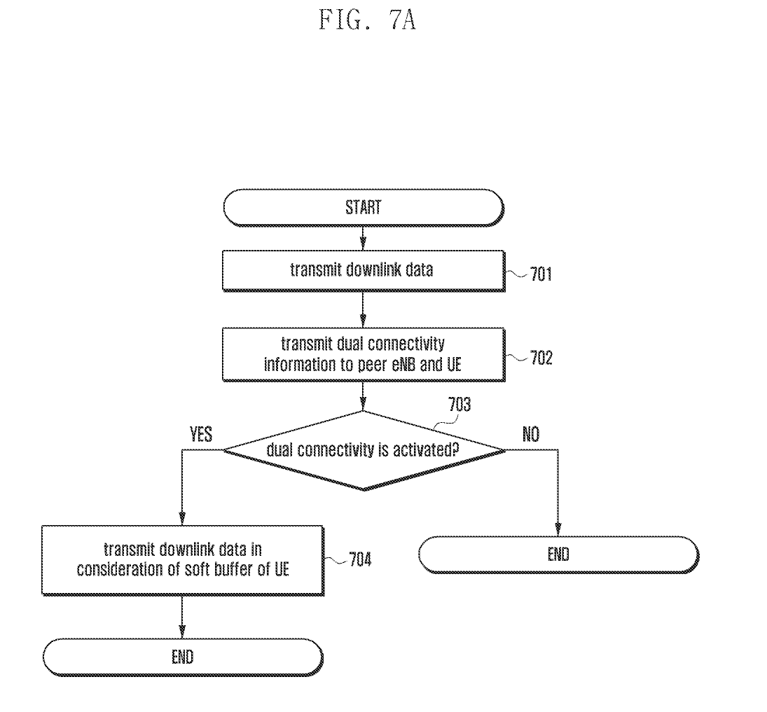

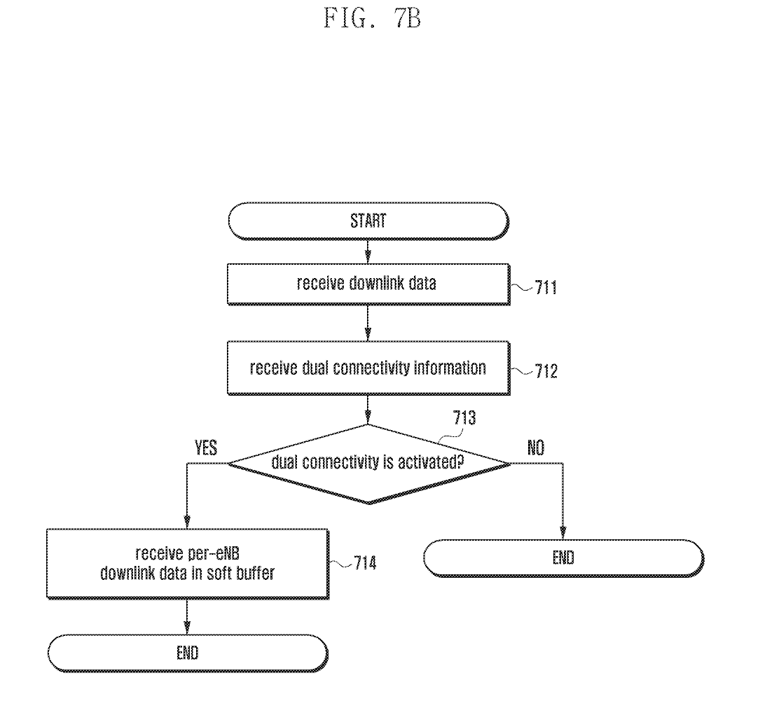

FIG. 7A is a flowchart illustrating a downlink data transmission procedure of an eNB in a dual connectivity environment according to an embodiment of the present disclosure, and FIG. 7B is a flowchart illustrating a downlink data reception procedure of a UE in a dual connectivity environment according to an embodiment of the present disclosure.

A description is made of the downlink transmission procedure of the eNB first.

Referring to FIG. 7A, the eNB performs downlink data transmission to the dual connectivity-enabled UE at operation 701. At this time, the eNB to which the dual connectivity-enabled UE is connected to is a macro eNB (or a pico eNB). In order to prepare for dual connectivity, the macro eNB (or pico eNB) transmits to the pico eNB (or macro eNB) the dual connectivity information through the X2 interface at operation 702. At this time, the macro eNB transmits the dual connectivity information to the UE through higher layer signaling. The dual connectivity information includes cell configuration information.

The eNB determines whether the UE has activated the dual connectivity mode to establish connections with the two eNBs at operation 703. If it is determined that the UE has activated the dual connectivity mode (if a MAC CE command is transmitted) at operation 703, the eNB transmits downlink data based on the soft buffer status of the UE at operation 704 as described in the above embodiments. Otherwise, if it is determined that the UE has not activated the dual connectivity mode, the eNB transmits downlink data assuming data transmission of single eNB.

Thereafter, a description is made of the downlink data reception procedure of the UE.

Referring to FIG. 7B, the dual connectivity-enabled UE receives the downlink data from the eNB at operation 711. At this time, the eNB to which the dual connectivity-enabled UE is connected to is a macro eNB (or a pico eNB). The dual connectivity-enabled UE receives dual connectivity information from the macro eNB (or pico eNB) through higher layer signaling at operation 712. The dual connectivity information includes cell configuration information.

The dual connectivity-enabled UE determines whether the dual connectivity-enabled UE has activated the dual connectivity mode at operation 713. If it is determined that the dual connectivity has been activated, the UE receives and buffers the downlink data transmitted by the macro and pico eNBs in the UE's soft buffer at operation 714 as described in the above embodiments. Otherwise, if it is determined that the dual connectivity has not been activated, the UE receives and buffers the downlink data from one eNB in the UE's soft buffer.

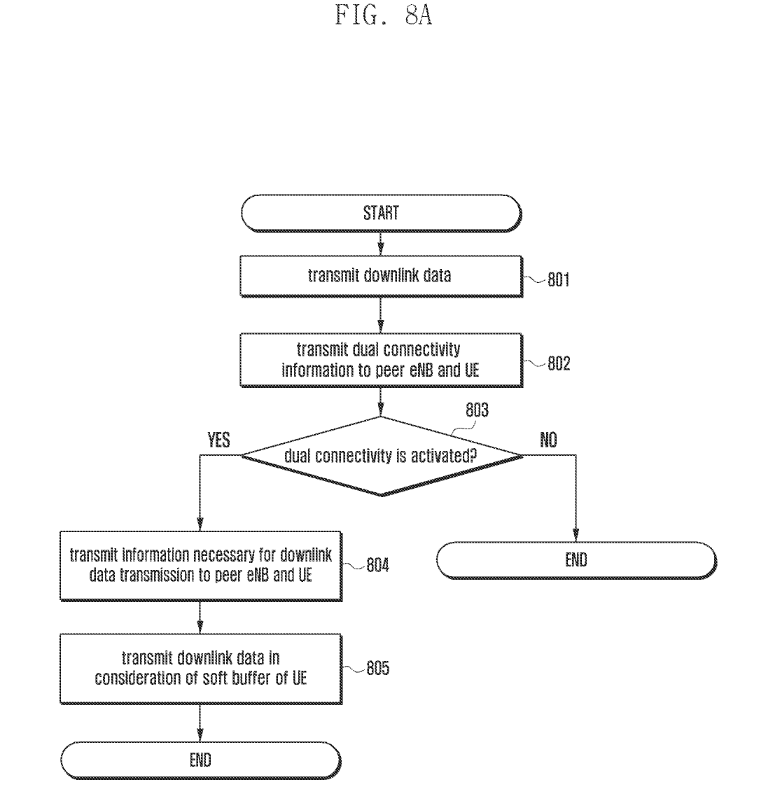

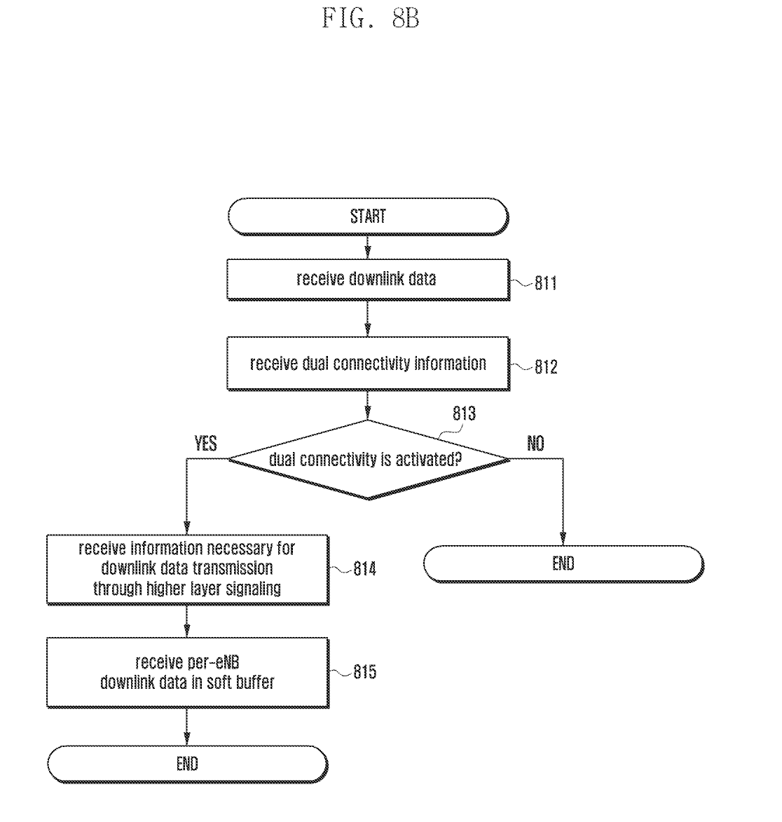

FIG. 8A is a flowchart illustrating a downlink data transmission procedure of an eNB in a dual connectivity environment according to an embodiment of the present disclosure, and FIG. 8B is a flowchart illustrating a downlink data reception procedure of a UE in a dual connectivity environment according to an embodiment of the present disclosure.

Referring to FIG. 8A, the eNB performs downlink data transmission to the dual connectivity-enabled UE at operation 801. At this time, the eNB to which the dual connectivity-enabled UE is connected to is a macro eNB (or a pico eNB). In order to prepare for dual connectivity, the macro eNB (or pico eNB) transmits to the pico eNB (or macro eNB) the dual connectivity information through the X2 interface at operation 802. At this time, the macro eNB transmits the dual connectivity information to the UE through higher layer signaling. The dual connectivity information includes cell configuration information.

The eNB determines whether the UE has activated the dual connectivity mode to establish connections with the two eNBs at operation 803. If it is determined that the UE has activated the dual connectivity mode (if a MAC CE command is transmitted) at operation 803, the eNB transmits another eNB participated in the dual connectivity the information necessary for downlink data transmission with segmentation of the soft buffer of the UE through the X2 interface at operation 804 as described in the above embodiments. The eNB also transmits to the UE the information necessary for downlink data transmission with segmentation of the soft buffer of the UE through higher layer signaling. The information necessary for segmenting the soft buffer of the UE includes the cell activation information and Ni as the required soft buffer capacity or a value in proportion thereto. The eNB transmits downlink data based on the soft buffer status of the UE at operation 805 as described in the above embodiments. Otherwise, if it is determined that the UE has not activated the dual connectivity mode at operation 803, the eNB transmits downlink data assuming data transmission of single eNB.

Thereafter, a description is made of the downlink data reception procedure of the UE.

Referring to FIG. 8B, the dual connectivity-enabled UE receives the downlink data from the eNB at operation 811. At this time, the eNB to which the dual connectivity-enabled UE is connected to is a macro eNB (or a pico eNB). The dual connectivity-enabled UE receives dual connectivity information from the macro eNB (or pico eNB) through higher layer signaling at operation 812. The dual connectivity information includes cell configuration information.

The dual connectivity-enabled UE determines whether the dual connectivity-enabled UE has activated the dual connectivity mode at operation 813. If it is determined that the dual connectivity has been activated, the UE receives the information necessary for downlink data transmission with segmentation of the soft buffer of the UE through higher layer signaling at operation 814. The information necessary for segmenting the soft buffer of the UE includes the cell activation information and Ni as the required soft buffer capacity or a value in proportion thereto. The UE receives and buffers the downlink data transmitted by the macro and pico eNBs in the UE's soft buffer at operation 815 as described in the above embodiments. Otherwise, if it is determined that the dual connectivity has not been activated at operation 813, the UE receives and buffers the downlink data from one eNB in the UE's soft buffer.

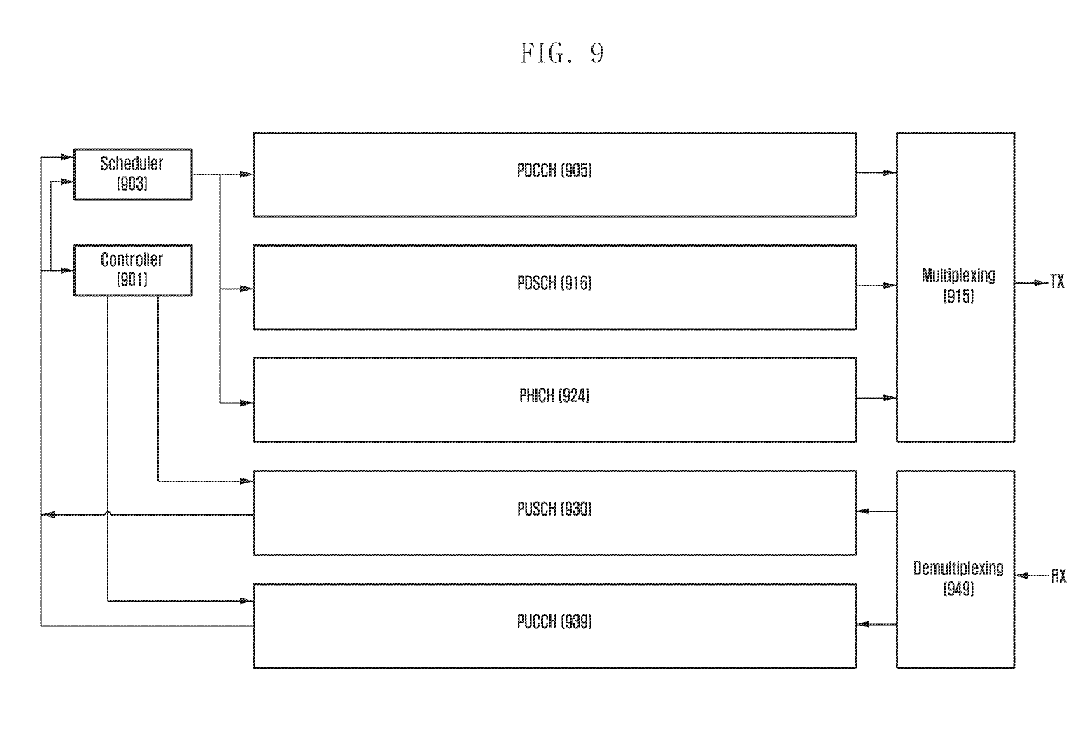

FIG. 9 is a block diagram illustrating a configuration of an eNB according to an embodiment of the present disclosure.

Referring to FIG. 9, the eNB comprises a transmitter including a Physical Downlink Control Channel (PDCCH) block 905, a Physical Downlink Shared Channel (PDSCH) block 916, a Physical Hybrid-ARQ Indicator Channel (PHICH) block 924, and a multiplexer 915, a receiver including a Physical Uplink Shared Channel (PUSCH) block 930, a Physical Uplink Control Channel (PUCCH) block 939, and a demultiplexer 949, a controller 901 for controlling of generating and transmitting downlink data based on the soft buffer of the UE, and a scheduler 903. Here, generating and transmitting the downlink data based on the soft buffer of the UE includes all of the operations according to the various embodiments of the present disclosure. Although the eNB may have a plurality of transmitters and receivers (except for PUCCH block) for data communication through a plurality of cell, the description is made under the assumption that the eNB has one transmitter and one receiver for explanation convenience.

The controller 901 which controls generating and transmitting downlink data based on the soft buffer of the UE adjusts the timings among the physical channels to the UE which is scheduled based on the data amount to be transmitted to the UE and available resource among of the system and informs on the adjustment result to the scheduler 903, the PDCCH block 905, the PDSCH block 916, the PHICH block 924, the PUSCH block 930, and the PUCCH block 939. The downlink data is generated and transmitted based on the soft buffer of the UE as described in the above embodiments. The PDCCH block 905 generates the control information under the control of the scheduler 903, and the multiplexer 915 multiplexes the control information with other signals. The PDSCH block 916 generates data under the control of the scheduler 903 as described in the above embodiments, and the multiplexer 915 multiplexes the data with other signals.

The PHICH block 924 generates HARQ ACK/NACK corresponding to the PUSCH transmitted by the UE under the control of the scheduler 903. The multiplexer 915 multiplexes the HARQ ACK/NACK with other signals.

The multiplexed signals are converted into an OFDM signal to be transmitted to the UE.

The PUSCH block 930 of the receiver acquires PUSCH data from the signal transmitted by the UE. The PUSCH block 930 transmits the decoding result, i.e., presence/absence of error, to the scheduler 903 which controls generating the downlink HARQ ACK/NACK and to the controller 901 which adjusts downlink HARQ ACK/NACK transmission timing.

The PUCCH block 930 acquires downlink ACK/NACK or Channel Quality Indication (CQI) from the signal transmitted by the UE. The acquired uplink ACK/NACK or CQI is transferred to the scheduler 903 for use in determining whether to retransmit PDSCH and select a Modulation and Coding Scheme (MCS). The uplink ACK/NACK is also transferred to the controller 901 for use in adjusting transmission timing of PDSCH.

More specifically, according to an embodiment of the present disclosure, the controller 901 transmits the dual connectivity information to another eNB and the UE, determines whether the dual connectivity mode is activated, and, if so, controls the eNB to generate downlink data based on the soft buffer of the UE and transmits the downlink data to the UE.

According to an embodiment of the present disclosure, the controller 901 transmits the dual connectivity information to a peer eNB and the UE, determines whether the dual connectivity mode is activated, transmits, if so, the required information to the peer eNB and the UE through higher layer signaling, and controls the eNB to generate downlink data based on the whole of the soft buffer of the UE and transmit the downlink data to the UE.

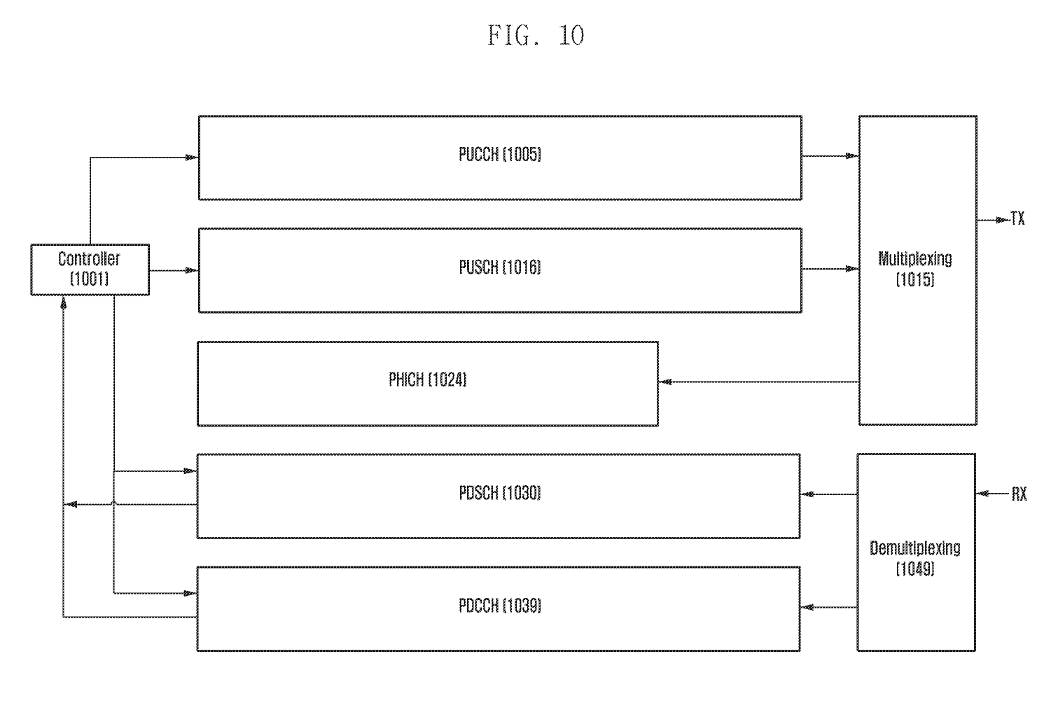

FIG. 10 is a block diagram illustrating a configuration of a UE according to an embodiment of the present disclosure.

Referring to FIG. 10, the UE comprises a transmitter including a PUCCH block 1005, a PUSCH block 1016, a multiplexer 1015, a receiver including a PHICH block 1024, a PDSCH block 1030, a PDCCH block 1039, and a demultiplexer 1049, and a controller 1001 which controls receiving downlink data from two eNBs and buffering the downlink data in the soft buffer. Although the UE may have a plurality of transmitters and receivers (except for the PUCCH block) for receiving downlink data through a plurality cells of the two eNBs, the description is made under the assumption that the UE has one transmitter and one receiver for explanation convenience.

According to an embodiment of the present disclosure, the controller 1001 which controls buffering the downlink data transmitted by the two eNBs in the soft buffer informs on the eNB which transmits downlink data and PDCCH amount which the eNB transmits to the UE in the self-scheduling or cross carrier scheduling situation, the information being acquired from DCI transmitted by the eNB, to the PUCCH block 1005, the PDSCH block 1030, and the PDCCH block 1039. The downlink data transmitted by the two eNBs are buffered in the soft buffer as described in the above embodiment.

The PUCCH block 1005 generates HARQ ACK/NACK or CQI as Uplink Control Information (UCI) under the control of the controller 1001, and the multiplexer 1015 multiplexes the HARQ ACK/NACK or CQI with other signals.

The PUSCH block 1016 extracts data to be transmitted, and the multiplexer 1015 multiplexes the data with other signals.

The multiplexed signals are converted to a Single Carrier Frequency Division Multiple Access (SC-FDMA) signal which is transmitted to the eNB based on the DL/UL HARQ-ACK transmission/reception timing.

The PHICH block 1024 of the receiver receives the PHICH signal which is demultiplexed by the demultiplexer 1049 from the signal transmitted by the eNB according to the DL/UL HARQ-ACK transmission/reception timing and acquires the HARQ ACK/NACK corresponding to PUSCH.

The PDSCH block 1030 receives the PDSCH signal which is demultiplexed by the demultiplexer 1049 from the signal transmitted by the eNB, buffers the PDSCH data in the soft buffer as described in the above embodiments, informs on the decoding result, i.e., presence/absence of error, to the PUCCH block 1005 for use in adjusting generation of uplink HARQ ACK/NACK and to the controller 1001 to adjust the uplink HARQ ACK/NACK transmission timing.

The PDCCH block 1039 receives the PDCCH signal which is demultiplexed by the demultiplexer 1049 and performs DCI format decoding to acquire the DCI from the decoded signal.

More specifically, according to an embodiment of the present disclosure, the controller 1001 controls the UE to receive the dual connectivity information from an eNB, determines whether the controller 1001 has activated the dual connectivity mode, and, if so, controls the UE to receive and buffer the eNB-specific downlink data in the UE's soft buffer.

According to an embodiment of the present disclosure, the controller 1001 controls the UE to receive the dual connectivity information form an eNB, determines whether the controller 1001 has activated the dual connectivity mode, and controls, if so, the UE to receive the necessary information through higher layer signaling and generate and transmit the downlink data based on the whole of the soft buffer of the UE.

As described above, the soft buffer size determination method of the present disclosure is advantageous in that the macro and pico eNBs serving the dual connectivity-enabled UE is capable of transmitting downlink data without decreasing data rate and allowing the UE to buffer the downlink data in the size-constrained buffer efficiently. In addition, the buffer size determination method of the present disclosure is advantageous in that the dual connectivity-enabled UE is capable of storing the downlink data received from one of or both the macro and pico eNBs as long as possible.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of a terminal for receiving downlink data in communication system supporting dual connectivity, the method comprising:
receiving the downlink data from a base station;
determining whether the terminal is configured with a secondary cell group (SCG);
determining, if the terminal is configured with the SCG, a size of a soft buffer per code block per cell based on a number of configured serving cells of the terminal; and
storing the received downlink data in the soft buffer based on the size of the soft buffer per code block per cell,
wherein the configured serving cells are included in a master cell group (MCG) and the SCG.

2. The method of claim 1, wherein the storing of the received downlink data comprises storing soft channel bits included in the received downlink data in the soft buffer.

3. The method of claim 2, wherein the storing of the received downlink data comprises discarding, if the soft channel bits included in the received downlink data are more than the size of the soft buffer per code block per cell, soft channel bits which are more than the size.

4. The method of claim 2, wherein the storing of the received downlink data comprises storing the received channel bits corresponding to a range of at least wₖ, wₖ₊₁, . . . , w_{mod (k+n}_{_{—}}_{SB-1, N}_{_{—}}_{cb)}, where:
$${n}_{SB} = min ( {N}_{cb} , ⌊ \frac{{N}_{soft}^{′}}{C \cdot ( {N}_{eNB 1 , cells}^{DL} + {N}_{eNB 2 , cells}^{DL} ) \cdot {K}_{MIMO} \cdot min ( {M}_{DL\_HARQ} , {M}_{limit} )} ⌋ ) ,$$
where:
N_{soft}′ is the size of the soft buffer,
N_{cb} is the size of the soft buffer per code block,
C is the number of code blocks,
N_{eNB1, cells}^{DL} is the number of configured serving cells of MCG,
N_{eNB2, cells}^{DL} is the number of configured serving cells of SCG,
K_{MIMO} is equal to 2 if transmission mode of the terminal is configured to two transport blocks and is equal to 1, if the transmission mode of the terminal is configured to one transport block,
M_{DL}_{_{—}}_{HARQ} is the maximum number of downlink hybrid automatic repeat request (HARQ) processes, and
Mₗᵢₘᵢₜ is a constant equal to 8.

5. The method of claim 1, further comprising:
receiving information on an available size of the soft buffer per code block from the base station,
wherein the determining of the size of the soft buffer per code block per cell is further based on the received information on the available size of the soft buffer per code block.

6. The method of claim 1, wherein the received downlink data is generated based on an available size of the soft buffer of the terminal.

7. The method of claim 6, wherein the available size of the soft buffer comprises the size of a soft buffer assigned to the MCG and the SCG.

8. A method for transmitting downlink data of a base station in communication system supporting dual connectivity, the method comprising:
configuring a secondary cell group (SCG) to a terminal;
generating the downlink data to be transmitted to the terminal based on an available size of a soft buffer of the terminal; and
transmitting the generated downlink data to the terminal,
wherein the transmitted downlink data is stored in the soft buffer of the terminal,
wherein a size of the soft buffer per code block per cell is determined based on a number of configured serving cells of the terminal, and
wherein the configured serving cells are included in a master cell group (MCG) and the SCG.

9. The method of claim 8, further comprising transmitting information on an available size of the soft buffer per code block to the terminal,
wherein the size of the soft buffer per code block per cell is determined further based on the transmitted information on the available size of the soft buffer per code block.

10. A terminal for receiving downlink data in communication system supporting dual connectivity, the terminal comprising:
a transceiver configured to transmit and receive a signal;
a controller configured:
to receive the downlink data from a base station,
to determine whether the terminal is configured with a secondary cell group (SCG),
to determine, if the terminal is configured with the SCG, a size of a soft buffer per code block per cell based on a number of configured serving cells of the terminal, and
to store the received downlink data in the soft buffer based on the size of the soft buffer per code block per cell,
wherein the configured serving cells are included in a master cell group (MCG) and the SCG.

11. The terminal of claim 10, wherein the controller is further configured to store soft channel bits included in the received downlink data in the soft buffer.

12. The terminal of claim 11, wherein the controller is further configured to discard, if the soft channel bits included in the received downlink data are more than the size of the soft buffer per code block per cell, soft channel bits which are more than the size.

13. The terminal of claim 11, wherein the controller is further configured to store the received channel bits corresponding to a range of at least wₖ, wₖ₊₁, . . . , w_{mod(k+n}_{_{—}}_{SB-1, N}_{_{—}}_{cb)}, where:
$${n}_{SB} = min ( {N}_{cb} , ⌊ \frac{{N}_{soft}^{′}}{C \cdot ( {N}_{eNB 1 , cells}^{DL} + {N}_{eNB 2 , cells}^{DL} ) \cdot {K}_{MIMO} \cdot min ( {M}_{DL\_HARQ} , {M}_{limit} )} ⌋ ) ,$$
where:
N_{soft}′ is the size of the soft buffer,
N_{cb} is the size of the soft buffer per code block,
C is the number of code blocks,
N_{eNB1, cells}^{DL} is the number of configured serving cells of MCG,
N_{eNB2, cells}^{DL} is the number of configured serving cells of SCG,
K_{MIMO} is equal to 2 if transmission mode of the terminal is configured to two transport blocks and is equal to 1, if the transmission mode of the terminal is configured to one transport block,
M_{DL}_{_{—}}_{HARQ} is the maximum number of downlink hybrid automatic repeat request (HARQ) processes, and
Mₗᵢₘᵢₜ is a constant equal to 8.

14. The terminal of claim 10, wherein the controller is further configured:
to receive information on an available size of the soft buffer per code block from the base station, and
to determine the size of the soft buffer per code block per cell further based on the received information on the available size of the soft buffer per code block.

15. The terminal of claim 10, wherein the received downlink data is generated based on an available size of the soft buffer of the terminal.

16. The terminal of claim 15, wherein the available size of the soft buffer comprises the size of a soft buffer assigned to the MCG and the SCG.

17. A base station for transmitting downlink data in communication system supporting dual connectivity, the base station comprising:
a transceiver configured to transmit and receive a signal;
a controller configured:
to configure a secondary cell group (SCG) to a terminal,
to generate the downlink data to be transmitted to the terminal based on an available size of a soft buffer of the terminal, and
to transmit the generated downlink data to the terminal,
wherein the transmitted downlink data is stored in the soft buffer of the terminal,
wherein a size of the soft buffer per code block per cell is determined based on a number of configured serving cells of the terminal, and
wherein the configured serving cells are included in a master cell group and the SCG.

18. The base station of claim 17,
wherein the controller is further configured to transmit information on an available size of the soft buffer per code block to the terminal, and
wherein the size of the soft buffer per code block per cell is determined further based on the transmitted information on the available size of the soft buffer per code block.
